(19) United States
(12) Patent Application Publication
(10) Pub. No.: US 2013/0182352 A1
(43) Pub. Date: Jul. 18, 2013

(54) RECORDING HEAD, AND DISK DRIVE WITH THE SAME

(71) Applicants: Takuya MATSUMOTO, Tokyo (JP); Tomoko TAGUCHI, Kunitachi-shi (JP)

(72) Inventors: Takuya MATSUMOTO, Tokyo (JP); Tomoko TAGUCHI, Kunitachi-shi (JP)

(73) Assignee: Kabushiki Kaisha Toshiba, Tokyo (JP)

(21) Appl. No.: 13/563,468

(22) Filed: Jul. 31, 2012

(30) Foreign Application Priority Data
Jan. 12, 2012 (JP) 2012-004349

(51) Int. Cl. G11B 5/265; G11B 5/60

(52) U.S. Cl. 360/234.3; 360/121; G9B/5.229; G9B/5.068

(57) ABSTRACT

According to one embodiment, a recording head includes a main pole formed of a soft magnetic material, a write shield pole formed of a soft magnetic material and on a trailing side of the main pole with a write gap, and side shields on both sides of the main pole in a track width direction and including nonmagnetic cavities formed of a nonmagnetic material in inner portions of the side shields. The side shields includes surfaces formed of a soft magnetic material and configured to be between a distal end portion of the main pole and the nonmagnetic cavity and between the recording medium and the nonmagnetic cavity.

### CROSS-REFERENCE TO RELATED APPLICATIONS

This application is based upon and claims the benefit of priority from prior Japanese Patent Application No. 2012-004349, filed Jan. 12, 2012, the entire contents of which are incorporated herein by reference.

### FIELD

Embodiments described herein relate generally to a recording head for perpendicular magnetic recording for use in a disk drive, and a disk drive including this recording head.

### BACKGROUND

A disk drive, such as a magnetic disk drive, comprises a magnetic disk, spindle motor, magnetic head, and carriage assembly, which are disposed in a case. The spindle motor supports and rotates the magnetic disk. The magnetic head reads data from and writes data to the magnetic disk. The carriage assembly supports the magnetic head for movement relative to the magnetic disk. The carriage assembly comprises a rotatable arm, and a suspension extending from the arm. The magnetic head is supported on the distal end of the suspension. The magnetic head comprises a slider attached to the suspension, and a head section provided on the slider. The head section comprises a recording head for writing and a read head for reading.

Magnetic heads for perpendicular magnetic recording have recently been proposed in order to increase the recording density and capacity of a magnetic disk drive or reduce its size. In one such magnetic head, a recording head comprises a main pole configured to produce a perpendicular magnetic field, a return pole or a write shield located on the trailing side of the main pole with a write gap therebetween and configured to close a magnetic path that leads to the magnetic disk, and a coil configured to pass magnetic flux through the main pole.

When a recording pattern is recorded along tracks of a magnetic disk, a recording magnetic field simultaneously leaks from both sides of the main pole in a track width direction. For decreasing this leak magnetic field, there has been suggested a recording head in which side shields magnetically joined to a write shield pole are provided on both sides of the main pole in the track width direction. Each of the side shields is formed of a laminate of a magnetic layer and a nonmagnetic layer which are laminated in a direction perpendicular to a medium-facing surface. In the magnetic layer of the side shield, a direction of a magnetization is established in an in-plane direction parallel to the medium-facing surface, owing to an antiferromagnetic coupling. In consequence, there has been expected an effect that magnetic flux from the main pole directly toward the side shield is prevented from leaking to the magnetic disk.

On the other hand, owing to the direction of the magnetization of the side shield, the magnetic flux from a distal end of the main pole cannot form a magnetic path which returns to the side shield through a soft magnetic layer of the magnetic disk, and hence, the magnetic flux flows in the track width direction of the side shield. In consequence, a strength of the recording magnetic field right under the distal end of the main pole decreases, and a quality of an on-track signal deteriorates.

### BRIEF DESCRIPTION OF THE DRAWINGS

FIG. 1 is a perspective view showing a hard disk drive (referred to as HDD) according to a first embodiment;

FIG. 2 is a side view showing a magnetic head and a suspension in the HDD;

FIG. 3 is an enlarged sectional view showing a head section of the magnetic head;

FIG. 4 is a perspective view schematically showing a recording head of the magnetic head;

FIG. 5 is a side view of an end portion of the recording head on an ABS side which is seen from a leading end side of a slider;

FIG. 6 is a diagram comparing and showing magnetic field strengths in a track width direction, concerning the recording head of the HDD according to the first embodiment, and recording heads according to comparative examples (a) and (b);

FIG. 7 is a diagram comparing and showing measurement results obtained by measuring a remaining bit error rate in an initial recording state while changing an adjacent recording track position, concerning the recording head of the HDD according to the first embodiment and the recording heads according to the comparative examples (a) and (b);

FIG. 8A is a diagram showing a graph where values of the magnetic field strength in a track center which are calculated from a recording magnetic field distribution, when conditions of the shortest distance CG between a nonmagnetic cavity and a main pole are changed, are plotted with respect to values of CG, in the HDD of the present embodiment;

FIG. 8B shows a graph where values of an adjacent fringe magnetic field strength which are calculated from the recording magnetic field distribution, when the conditions of the shortest distance CG between the nonmagnetic cavity and the main pole are changed, are plotted with respect to the values of CG, in the HDD of the present embodiment;

FIG. 9 is a perspective view schematically showing a recording head of an HDD according to a second embodiment;

FIG. 10 is a side view of an end portion of the recording head on an ABS side, which is seen from a leading end side of a slider;

FIG. 11 is a perspective view schematically showing a recording head of an HDD according to a third embodiment;

FIG. 12 is a side view of an end portion of the recording head on an ABS side, which is seen from a leading end side of a slider;

FIG. 13 is a perspective view schematically showing a recording head of an HDD according to a fourth embodiment;

FIG. 14 is a side view of an end portion of the recording head on an ABS side, which is seen from a leading end side of a slider; and

FIG. 15 is a diagram comparing and showing magnetic field strengths in a track width direction, concerning the recording head in the HDD according to the fourth embodiment, and the recording head according to the comparative example (a).

### DETAILED DESCRIPTION

Various embodiments will be described hereinafter with reference to the accompanying drawings. In general, according to one embodiment, a recording head comprises: a main pole formed of a soft magnetic material and configured to generate a recording magnetic field in a direction perpendicular to a recording layer of a recording medium; a write shield pole formed of a soft magnetic material and on a trailing side of the main pole with a write gap; and side shields on both sides of the main pole in a track width direction and magnetically divided from the main pole and comprising nonmagnetic cavities formed of a nonmagnetic material in inner portions of the side shields. The side shields comprise surfaces formed of a soft magnetic material and configured to be between a distal end portion of the main pole and the nonmagnetic cavity and between the recording medium and the nonmagnetic cavity.

### First Embodiment

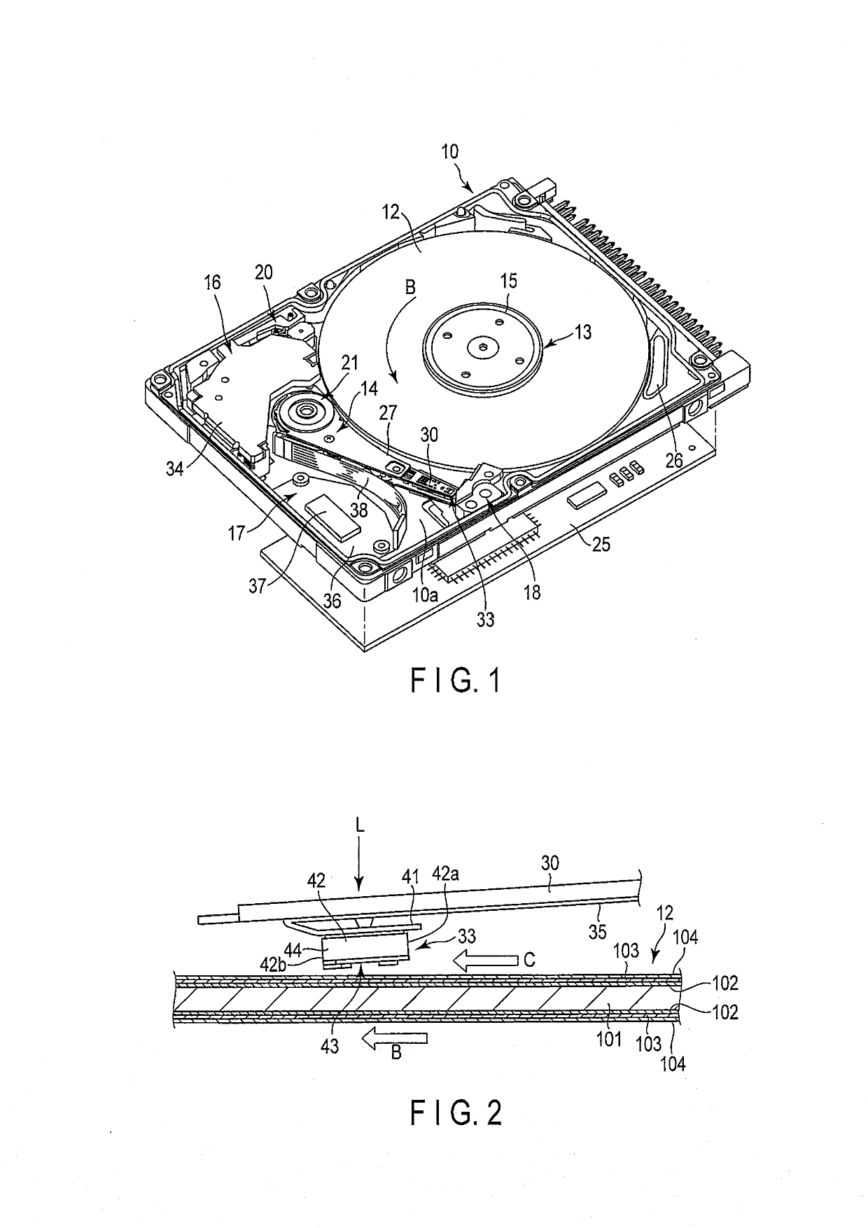

FIG. 1 shows the internal structure of a hard disk drive (HDD) as a disk drive according to a first embodiment with its top cover removed, and FIG. 2 shows a flying magnetic head. As shown in FIG. 1, the HDD comprises a housing 10. The housing 10 comprises a base 10a in the form of an open-topped rectangular box and a top cover (not shown) in the form of a rectangular plate. The top cover is attached to the base by screws such that it closes the top opening of the base. Thus, the housing 10 is kept airtight inside and can be ventilated through a breather filter 26.

The base 10a carries thereon a magnetic disk 12, for use as a recording medium, and a drive section. The drive section comprises a spindle motor 13, plurality (e.g., two) of magnetic heads 33, head actuator 14, and voice coil motor (VCM) 16. The spindle motor 13 supports and rotates the magnetic disk 12. The magnetic heads 33 record and reproduce data on and from the disk 12. The head actuator 14 supports the magnetic heads 33 for movement relative to the surfaces of the disk 12. The VCM 16 rotates and positions the head actuator. The base 10a further carries a ramp loading mechanism 18, inertial latch 20, and board unit 17. The ramp loading mechanism 18 holds the magnetic heads 33 in a position off the magnetic disk 12 when the magnetic heads are moved to the outermost periphery of the magnetic disk. The inertial latch 20 holds the head actuator 14 in a retracted position if the HDD is jolted, for example. Electronic components, such as a preamplifier, head IC, etc., are mounted on the board unit 17.

A control circuit board 25 is attached to the outer surface of the base 10a by screws and faces a bottom wall of the base. The circuit board 25 controls the operations of the spindle motor 13, VCM 16, and magnetic heads 33 through the board unit 17.

As shown in FIG. 1, the magnetic disk 12 is coaxially fitted onto a hub of the spindle motor 13, and is clamped by a clamp spring 15 attached to an upper end of the hub by screws, and fixed to the hub. The magnetic disk 12 is rotated at a predetermined speed in an arrow-B direction by the spindle motor 13 as a drive motor.

The head actuator 14 comprises a bearing portion 24 fixed to the bottom wall of the base 10a, and arms 27 extending from the bearing portion 24. The arms 27 are positioned in parallel with the surfaces of the magnetic disk 12, and mutually positioned via a predetermined space, to extend from the bearing portion 24 in the same direction. The head actuator 14 comprises an elongated plate-shaped suspension 30 which is elastically deformable. The suspension 30 is constituted of a leaf spring, and a base end thereof is fixed to a distal end of each of the arms 27 by spot welding or bonding, to extend from the arm. Each of the suspensions 30 may be formed integrally with the corresponding arm 27. At an extending end of the suspension 30, the magnetic head 33 is supported. The arms 27 and the suspensions 30 constitute a head suspension, and this head suspension and the magnetic heads 33 constitute a head suspension assembly.

As shown in FIG. 2, each of the magnetic heads 33 includes a substantially rectangular parallelepiped slider 42, and a head section 44 for recording and reproducing, which is provided at an outflow end (a trailing end) of this slider. The magnetic head 33 is fixed to a gimbal spring 41 provided at the distal end of the suspension 30. To the magnetic head 33, a head load L toward the surface of the magnetic disk 12 is applied, by an elasticity of the suspension 30. Two arms 27 are positioned in parallel with each other with a predetermined space. The suspension 30 and the magnetic head 33 attached to these arms face each other interposing the magnetic disk 12 therebetween.

Each of the magnetic heads 33 is electrically connected to a main FPC 38 described later via a relay flexible printed circuit board (hereinafter referred to as the relay FPC) 35 fixed to the suspension 30 and the arm 27.

As shown in FIG. 1, the board unit 17 includes an FPC main body 36 formed by the flexible printed circuit board, and the main FPC 38 extending from this FPC main body. The FPC main body 36 is fixed to the bottom surface of the base 10a. On the FPC main body 36, a preamplifier 37 and electronic components including a head IC are mounted. The extending end of the main FPC 38 is connected to the head actuator 14, and connected to the magnetic head 33 via each of the relay FPCs 35.

The VCM 16 includes a support frame (not shown) extending from a bearing portion 21 in a direction opposite to the arm 27, and a voice coil supported by the support frame. In a state where the head actuator 14 is incorporated in the base 10a, the voice coil is positioned between a pair of yokes 34 fixed to the base 10a, and constitutes the VCM 16 together with these yokes and magnets fixed to the yokes.

When electricity is conducted through the voice coil of the VCM 16 while the magnetic disk 12 rotates, the head actuator 14 rotates. The magnetic head 33 is moved onto a desirable track of the magnetic disk 12, and positioned. In this case, the magnetic head 33 is moved between an inner peripheral edge and an outer peripheral edge of the magnetic disk, in a radial direction of the magnetic disk 12.

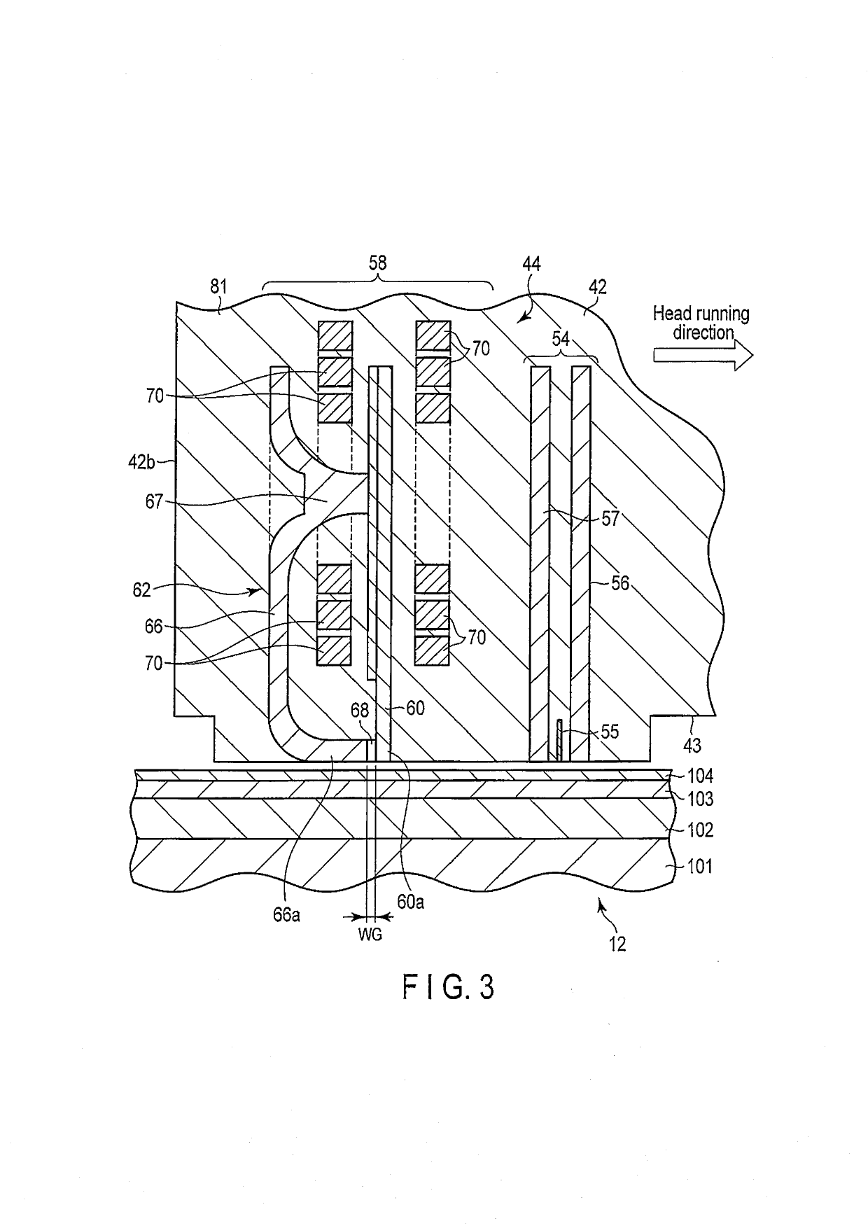

Next, constitutions of the magnetic disk 12 and the magnetic head 33 will be described in detail. FIG. 3 is an enlarged sectional view showing the head section 44 of the magnetic head 33 and the magnetic disk.

As shown in FIG. 1 to FIG. 3, the magnetic disk 12 includes a substrate 101 made of a nonmagnetic material and formed in, for example, a disc-like shape having a diameter of about 2.5 inches. On each of the surfaces of the substrate 101, there are laminated, in order, a soft magnetic layer 102 as an underlayer which is made of a material showing soft magnetic characteristics; a magnetic recording layer 103, in an upper layer portion of the soft magnetic layer, which has a magnetic anisotropy in a direction perpendicular to a disk surface; and a protective film layer 104 in an upper layer portion of the magnetic recording layer.

As shown in FIG. 2 and FIG. 3, the magnetic head 33 is constituted as a flying type head, and includes the slider 42 formed in the substantially rectangular parallelepiped shape, and the head section 44 formed at the outflow end (trailing) side of the slider. The slider 42 is formed of, for example, a sintered material (Altic) of alumina and titanium carbide, and the head section 44 is formed of a thin film.

The slider 42 has a rectangular disk facing surface (an air bearing surface (ABS)) 43 which faces the surface of the magnetic disk 12. The slider 42 floats upward owing to an air current C generated between the disk surface and the disk facing surface 43 by the rotation of the magnetic disk 12. A direction of the air current C matches a rotating direction B of the magnetic disk 12. The slider 42 is located above the surface of the magnetic disk 12 so that a longitudinal direction of the disk facing surface 43 substantially matches the direction of the air current C.

The slider 42 includes a leading end 42a positioned on an inflow side of the air current C, and a trailing end 42b positioned on an outflow side of the air current C. In the disk facing surface 43 of the slider 42, a not-shown leading step, trailing step, side step, negative pressure cavity and the like are formed.

As shown in FIG. 3, the head section 44 comprises a reproducing head 54 and a magnetic recording head 58 formed by a thin film process at the trailing end 42b of the slider 42, and is formed as a separating type magnetic head.

The reproducing head 54 comprises a magnetic film 55 showing a magnetoresistive effect, and shield films 56 and 57 arranged on a trailing side and a leading side of the magnetic film 55 to sandwich the magnetic film 55 therebetween. Lower ends of the magnetic film 55 and the shield films 56 and 57 are exposed on the disk facing surface 43 of the slider 42.

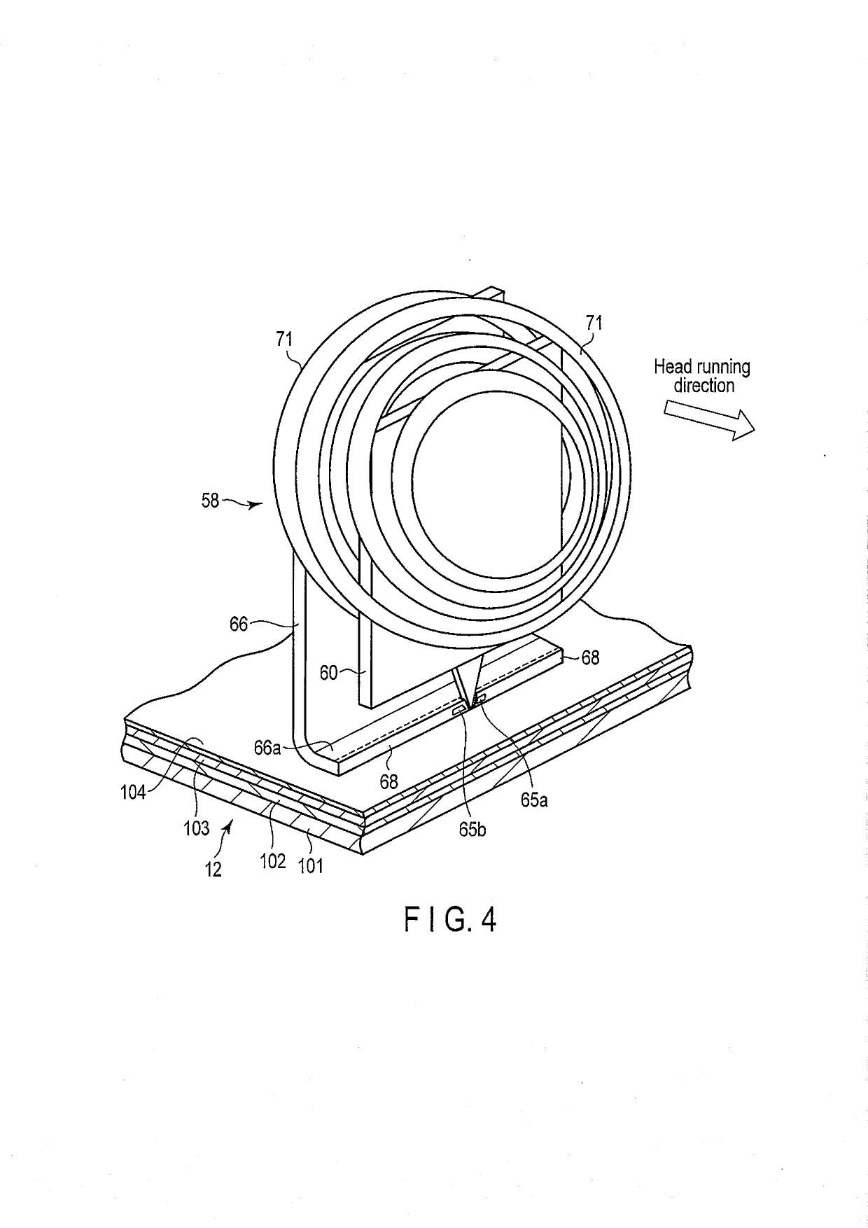

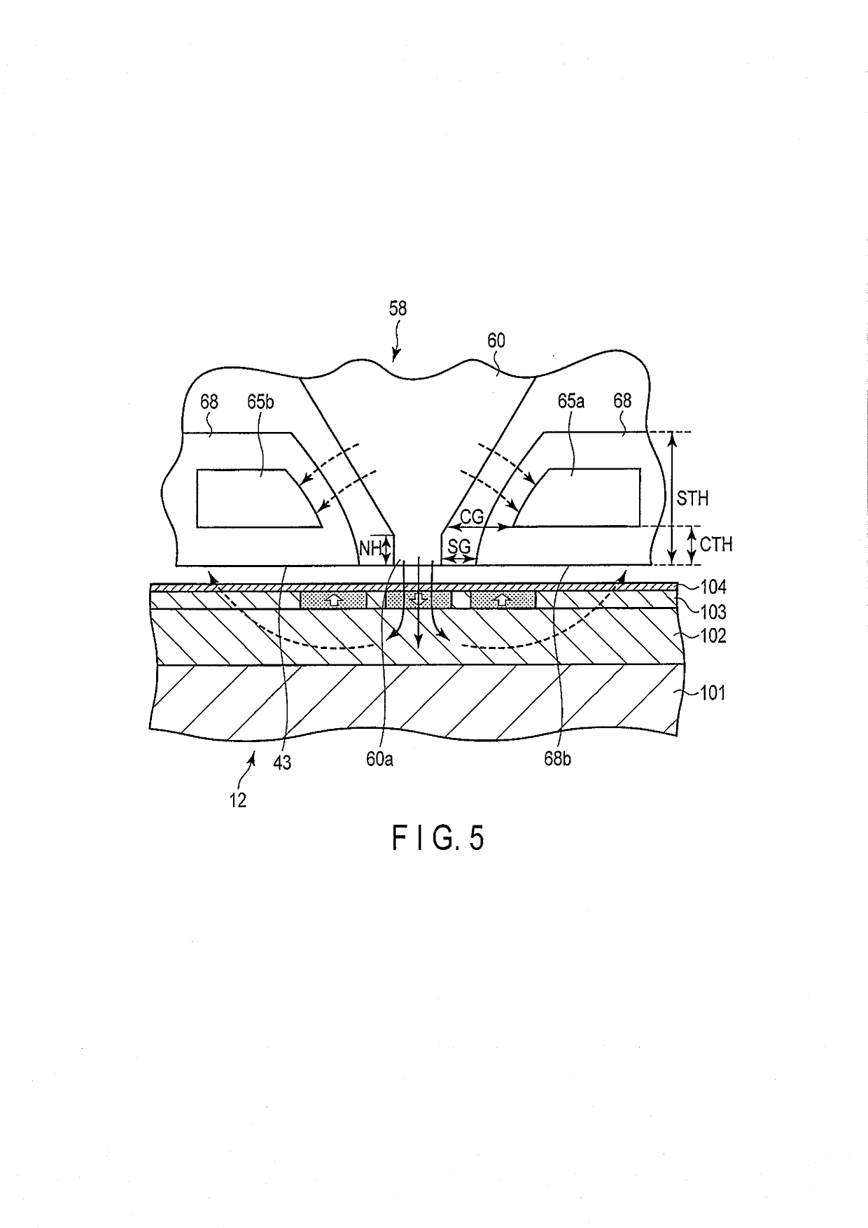

The recording head 58 is provided on the side of the trailing end 42b of the slider 42 with respect to the reproducing head 54. FIG. 4 is a perspective view schematically showing the recording head 58 and the magnetic disk 12, and FIG. 5 is an enlarged side view showing a main pole distal end portion and a side shield portion of a recording head part.

As shown in FIGS. 3 to 5, the recording head 58 comprises a main pole 60 made of a soft magnetic material having a high permeability and a high saturated magnetic flux density, to generate a recording magnetic field in a direction perpendicular to the surface of the magnetic disk 12; a write shield pole (a return pole) 66 made of a soft magnetic material, located on a trailing side of the main pole 60 with a write gap, and provided to efficiently close a magnetic path via the soft magnetic layer 102 right under the main pole; a connecting portion 67 connecting an upper portion of the main pole 60 to the write shield pole 66; a pair of side shields 68 made of a single layer of a soft magnetic material, on both sides of the main pole 60 in the track width direction on the main pole and magnetically divided from the main pole at the ABS 43, and arranged to combine with the write shield pole 66; and a recording coil 71 disposed to wind around a magnetic path including the main pole 60 and the write shield pole 66, thereby passing the magnetic flux through the main pole 60, when a recording signal is written in the magnetic disk 12. The side shields 68 include, in part thereof, nonmagnetic cavities 65a and 65b having nonmagnetic properties. A current to be supplied to the recording coil 71 is controlled by an HDD controller.

The main pole 60 extends substantially perpendicularly to the surface of the magnetic disk 12. A distal end portion 60a of the main pole 60 on the magnetic disk 12 side is tapered toward the disk surface, and the distal end portion 60a is formed in a pillar-like shape having a smaller width than another portion. The end surface of the main pole 60 is exposed on the disk facing surface 43 of the slider 42. A width of the distal end portion 60a of the main pole 60 substantially corresponds to a track width in the magnetic disk 12.

The write shield pole 66 is formed substantially in an L-shape, and a distal end portion 66a thereof is formed in an elongated rectangular shape. The end surface of the write shield pole 66 is exposed on the ABS 43 of the slider 42. A leading-side end surface of the distal end portion 66a extends along the track width direction of the magnetic disk 12. This leading-side end surface faces the trailing-side end surface of the main pole 60 in parallel with a write gap WG.

In the present embodiment, the pair of side shields 68 are formed of a high-permeability material integrally with the distal end portion 66a of the write shield pole 66, and project from the leading-side end surface of the distal end portion 66a toward the leading end side of the slider 42. The side shields 68 extend from the leading-side end surface of the write shield pole 66 to a level position beyond the leading-side end surface of the main pole 60.

In the present embodiment, as shown in FIG. 5, the shortest distance SG between the side surface of the main pole 60 in the track width direction and the side surface of the side shield 68 which faces the main pole is set to be equal to or smaller than two tracks of a track pitch determined in the HDD. The nonmagnetic cavities 65a and 65b face the side surfaces of the main pole 60 and the surface of the magnetic disk 12 via magnetic regions of the side shields 68, respectively. That is, between the nonmagnetic cavity 65a or 65b and the main pole 60 and between the nonmagnetic cavity and the magnetic disk 12, the magnetic regions of the side shield 68 is present. In this manner, the side shields 68 are arranged to be magnetically separated from the main pole 60 on both the sides of the main pole in the track width direction. The whole surfaces of the side shields which face the tapered distal end portion of the main pole and the magnetic disk are made of the nonmagnetic material. Moreover, the side shields 68 comprise the nonmagnetic cavities 65a and 65b formed of the nonmagnetic material, in inner portions which do not face the main pole 60 and the magnetic disk 12.

The nonmagnetic cavities 65a and 65b are arranged at such positions that the shortest distance CG between the main pole 60 and each nonmagnetic cavity satisfies a relation of SG×3<CG<SG×5 in which SG is the shortest distance SG between the main pole 60 and the side shield 68. A distance CTH from the ABS 43 to the nonmagnetic cavity 65a or 65b is preferably larger (higher) than a distance NH from the ABS to the tapered portion of the main pole 60.

The nonmagnetic cavities 65a and 65b may be filled with a magnetic material.

In the recording head 58, the soft magnetic material constituting the main pole 60, the write shield pole 66 and the side shields 68 can be selected from an alloy containing at least one of Fe, Co and Ni, and a compound, and used. As shown in FIG. 3, the reproducing head 54 and the recording head 58, excluding portions exposed on the ABS 43 of the slider 42, are covered with a nonmagnetic protective insulating film 81. The protective insulating film 81 constitutes an outer shape of the head section 44.

According to the HDD comprising the above constitution, when the VCM 16 is driven, the head actuator 14 rotates. The magnetic head 33 is moved onto the desirable track of the magnetic disk 12, and positioned. Moreover, the magnetic head 33 flies upward by the air current C generated between the disk surface and the ABS 43 by the rotation of the magnetic disk 12. When the HDD operates, the ABS 43 of the slider 42 faces the disk surface via a space. As shown in FIG. 2, the magnetic head 33 flies upward so that the recording head 58 part of the head section 44 takes an inclined posture closest to the surface of the magnetic disk 12. In this state, recording information is read from the magnetic disk 12 by the reproducing head 54, and information is written in the magnetic disk 12 by the recording head 58.

Upon recording or writing information, the recording coil 71 excites the main pole 60, and a perpendicular recording magnetic field is applied from the main pole to the recording layer 103 of the magnetic disk 12 right under the main pole, to record the information with a desirable track width.

In this case, when the side shields 68 are provided on both the sides of the main pole 60, a write signal quality in the write tracks is not lowered, but it is possible to suppress a magnetic flux leak from the distal end portion 66a of the main pole 60 to the adjacent track. Moreover, when the side shields 68 are provided with the nonmagnetic cavities 65a and 65b having nonmagnetic properties, magnetic coupling of the main pole 60 with the side shields 68 can be weakened. It is possible to enhance the quality of an on-track signal, while suppressing the magnetic flux leaking from the side shields 68 to the recording layer of the magnetic disk 12. In consequence, a high track density of the recording layer of the magnetic disk 12 can be achieved, and it is possible to enhance a recording density of the HDD.

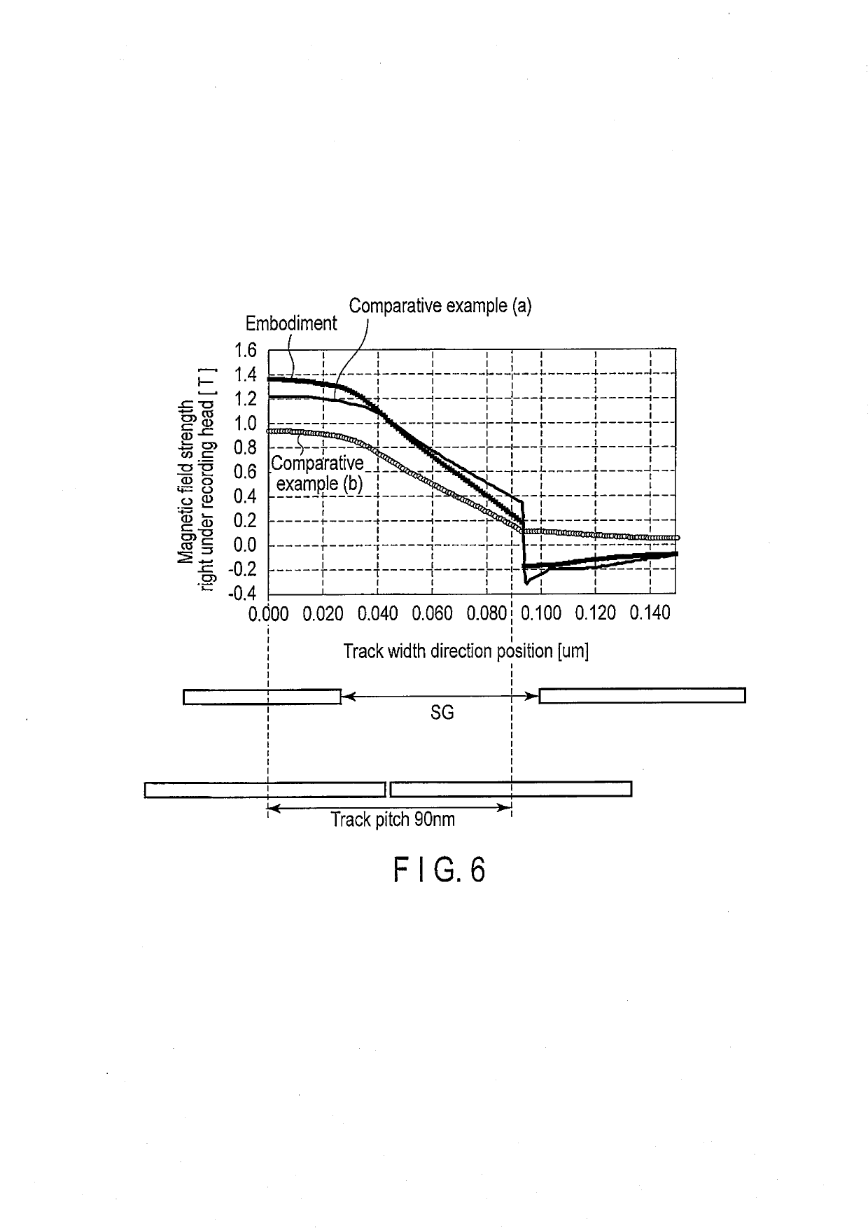

FIG. 6 compares and shows profiles of an off-track direction in recording magnetic field distributions generated from recording heads, concerning the recording head 58 of the HDD according to the present embodiment having the above constitution, the recording head according to comparative example (a), and the recording head according to comparative example (b). The recording head of the comparative example (a) comprises side shields which do not have nonmagnetic cavities, and the recording head of the comparative example (b) comprises side shields in which a magnetic layer and a nonmagnetic layer are alternately laminated in a direction orthogonal to a recording medium surface. It is to be noted that in FIG. 6, the main pole 60 is formed of a magnetic material of a saturated magnetic flux density Bs1=2.4 T, and the side shields 68 are formed of a magnetic material of a saturated magnetic flux density BS3=1.9 T.

In FIG. 6, a position of a track width direction position=0 is a center position of the track width direction of the main pole 60 in the recording head. A line of black squares, a solid line and a line of o indicate maximum magnetic field profiles at points in a one-side off-track direction from a track center in the head magnetic field distributions generated from the ABSs 43 of the recording head 58 of the present embodiment, the recording head of the comparative example (a) and the recording head of the comparative example (b), respectively. The profiles with a track pitch of 90 nm are compared. For raising a track density, it is necessary to suppress the magnetic field distribution in the adjacent track, and to suppress an adjacent track erasing phenomenon. In the recording head 58 of the present embodiment, the magnetic field strength in the center of the adjacent track is suppressed, and the magnetic field strength in the track center increases, as compared with the comparative example (a). When the recording head of such a head magnetic field distribution is used, the enhancement of a linear-direction density by improving an on-track signal SN and the enhancement of a track-direction density by suppressing the adjacent track erasing can be achieved. High-density recording can be realized.

It is seen that the recording head according to the comparative example (b) can decrease the leak magnetic field to the adjacent track as compared with the recording head according to the present embodiment. However, the magnetic field strength right under the main pole remarkably deteriorates, and hence the on-track signal SN deteriorates. In the recording head of the comparative example (b), the linear-direction density deteriorates, and hence it becomes difficult to achieve the high density.

As described above, in the HDD comprising the recording head according to the present embodiment, a recording ability of the on-track signal can be enhanced. Moreover, information of the adjacent track can be prevented from being erased, and hence the high recording density can be realized.

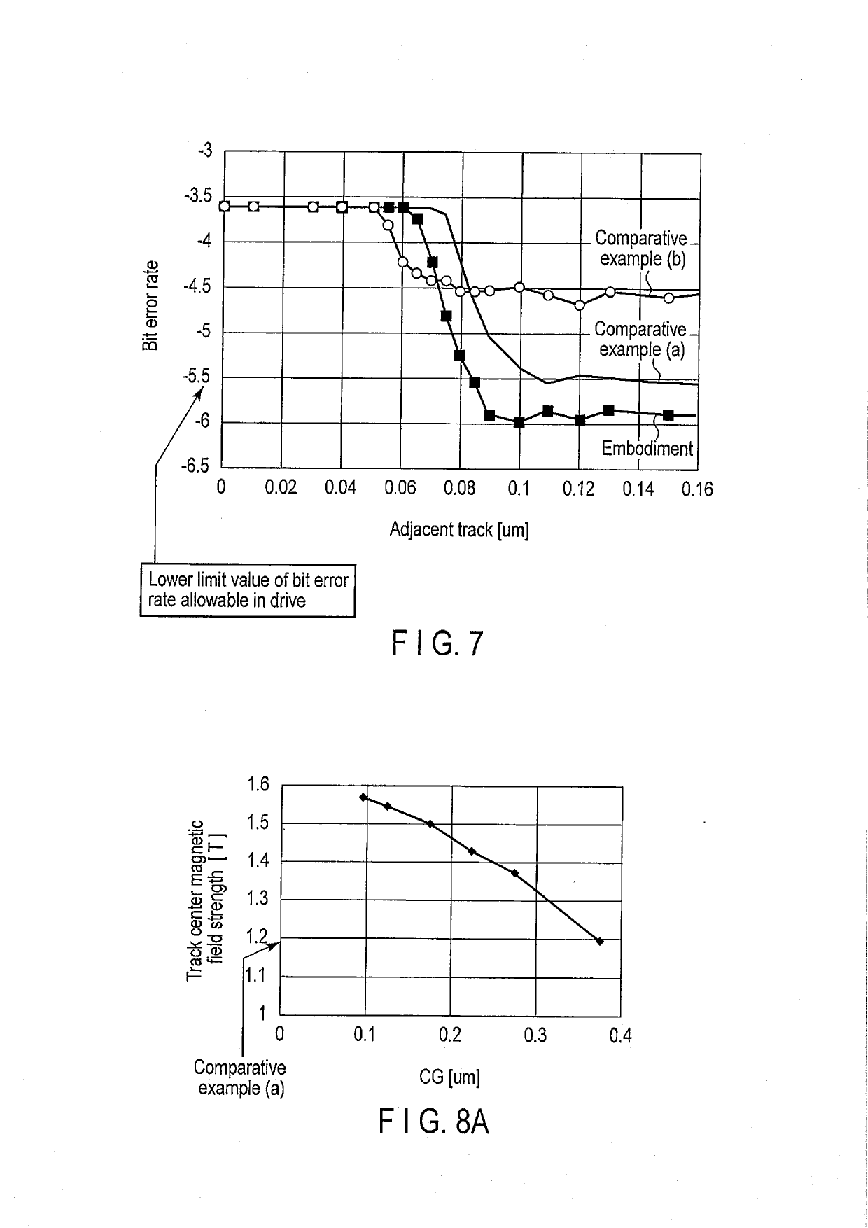

In FIG. 7, the recording head according to the present embodiment and the recording heads of the comparative examples (a) and (b) are used, to measure a remaining bit error rate in an initial recording state while changing an adjacent recording track position. Random data was used in both initial recording and adjacent recording. Moreover, the number of times of performed adjacent recording was 1000 times.

In FIG. 7, a line of black squares, a solid line and a line of o indicate measurement results obtained by measuring the remaining bit error rate in the initial recording state while changing the adjacent recording track position by use of the recording head 58 of the present embodiment, the recording head of the comparative example (a) and the recording head of the comparative example (b), respectively. According to the present embodiment, a lower limit value of the bit error rate allowable in the HDD is 10-5.5. When TPI which can be achieved from the adjacent track position satisfying this lower limit value is calculated, the recording head of the present embodiment has 300 kTPI. On the other hand, the recording head of the comparative example (a) deteriorates at 240 kTPI. It is seen that when the recording head of the present embodiment is used, the track-direction density can be enhanced, and the high density can be achieved.

When the recording head of the comparative example (b) is used, the magnetic field strength right under the main pole remarkably deteriorates as described with reference to FIG. 6. Therefore, an original bit error rate deteriorates, and the high recording density of the HDD cannot be achieved.

According to the present embodiment, for example, the shortest distance SG between the main pole 60 and each of the side shields 68 is 75 nm, and the recording track pitch of the magnetic disk 12 is 90 nm. The magnetic field strength at a position of 90 nm which is the center of the adjacent track is calculated as an adjacent fringe magnetic field, and used as an index of the magnetic field applied from the magnetic head which influences a signal of the adjacent track.

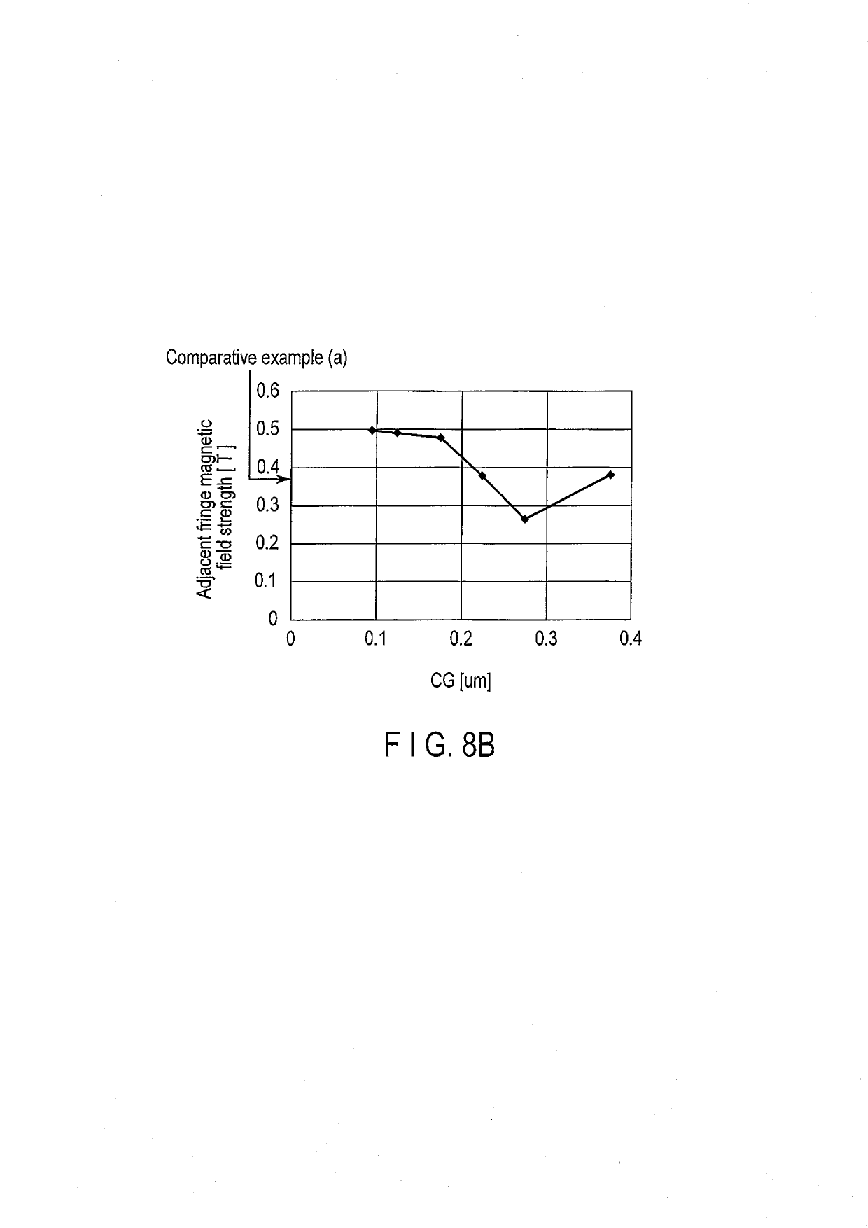

FIG. 8A and FIG. 8B show graphs in which the value of the magnetic field strength in the track center and the value of the adjacent fringe magnetic field strength calculated from the recording magnetic field distributions, when conditions of the shortest distance CG between each nonmagnetic cavity and the main pole are changed, are plotted with respect to values of CG, respectively.

As shown in FIG. 8A, it is seen that in the present embodiment, the side shields 68 are provided with the nonmagnetic cavities 65a and 65b, and hence the magnetic field strength in the track center increases as compared with the comparative example (a). When CG>SG×5, an effect obtained by providing the nonmagnetic cavities disappears, and the magnetic field strength becomes equal to that of the comparative example (a). On the other hand, as shown in FIG. 8B, the adjacent fringe magnetic field strength increases as compared with the comparative example (a). When CG>SG×3, the magnetic field leaking to the adjacent track cannot be suppressed.

In consequence, it is seen that when the nonmagnetic cavities are provided so that the shortest distance CG between each nonmagnetic cavity and the main pole is in a range of SG×3<CG<SG×5, the linear-direction density and the track-direction density can be enhanced, and the high-density recording can be achieved, as compared with the recording head structures of the comparative examples.

As described above, according to the present embodiment, it is possible to obtain a magnetic recording head which can enhance the quality of an on-track signal and achieve a high recording density, while preventing the deterioration or erasing of recorded information in an adjacent track region, and to obtain a disk drive including this head.

### Second Embodiment

Next, a recording head of an HDD according to a second embodiment will be described.

In the recording head of the HDD according to the second embodiment, a constitution of nonmagnetic cavities is mainly different from the first embodiment, and the other constitutions are the same as in the recording head of the first embodiment. The same parts as in the first embodiment will be denoted with the same reference numerals as in the first embodiment, and detailed description thereof will be omitted.

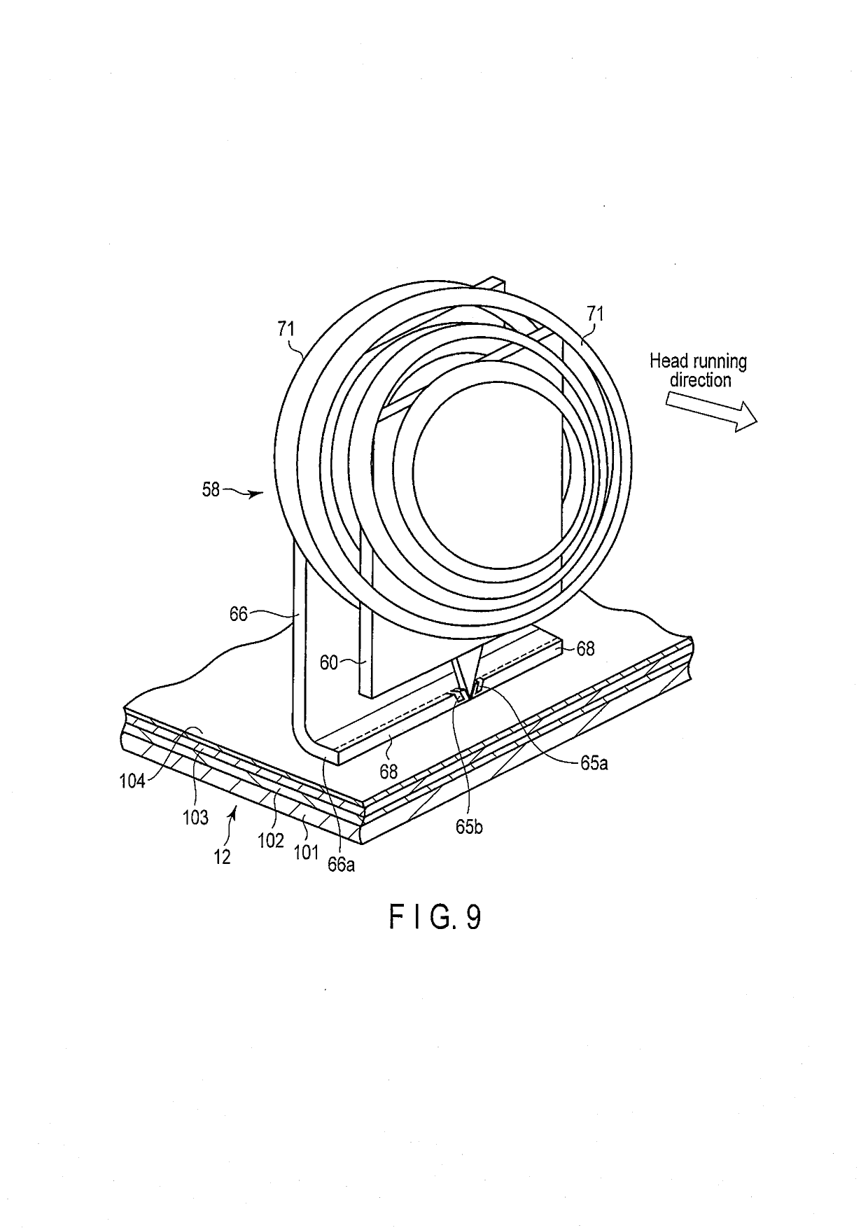

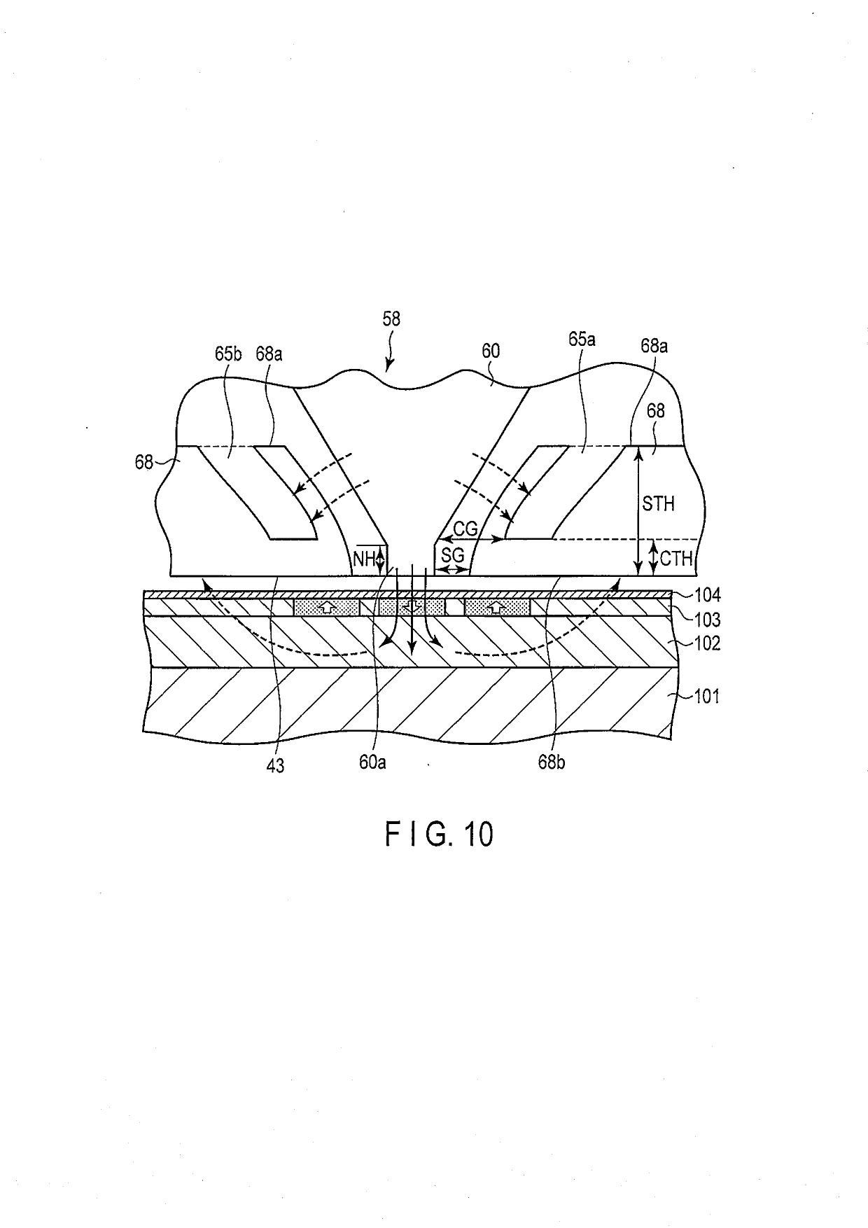

FIG. 9 is a perspective view schematically showing a recording head 58 of the HDD and a magnetic disk 12, and FIG. 10 is a side view of the recording head seen from a leading end side of a slider.

As shown in FIG. 9 and FIG. 10, according to the second embodiment, the recording head 58 comprises a main pole 60 formed of a soft magnetic material having a high permeability and a high saturated magnetic flux density, to generate a recording magnetic field in a direction perpendicular to the surface of the magnetic disk 12; a write shield pole 66 made of a soft magnetic material, disposed on a trailing side of the main pole 60 with a write gap, and provided to efficiently close a magnetic path via a soft magnetic layer 102 right under the main pole; a connecting portion 67 connecting an upper portion of the main pole 60 to the write shield pole 66; a pair of side shields 68 made of a single layer of a soft magnetic material, on both sides of the main pole 60 in a track width direction on the main pole and magnetically divided from the main pole at an ABS 43, and arranged to combine with the write shield pole 66; and a recording coil 71 disposed to wind around a magnetic path including the main pole 60 and the write shield pole 66, thereby passing magnetic flux through the main pole 60, when a signal is written in the magnetic disk 12. The side shields 68 include, in part thereof, nonmagnetic cavities 65a and 65b having nonmagnetic properties. A current to be supplied to the recording coil 71 is controlled by an HDD controller.

The pair of side shields 68 are formed of a high-permeability material integrally with a distal end portion 66a of the write shield pole 66, and project from the leading-side end surface of the distal end portion 66a toward a leading end side of a slider 42. Each of the side shields 68 extends from the leading-side end surface of the write shield pole 66 to a level position beyond the leading-side end surface of the main pole 60.

In the second embodiment, part of the nonmagnetic cavities 65a and 65b provided in the side shields 68 is configured to open in a boundary surface 68a between the main pole 60 and an upper portion of each of the side shields 68. The nonmagnetic cavities 65a and 65b face the side surfaces of the main pole 60 and the surface of the magnetic disk 12 via magnetic regions of the side shields 68, respectively. That is, between the nonmagnetic cavity 65a or 65b and the main pole 60 and between the nonmagnetic cavity and the magnetic disk 12, the magnetic regions of the side shield 68 are present.

In the present embodiment, as shown in FIG. 10, the shortest distance SG between the side surface of the main pole 60 in the track width direction and the side surface of the side shield 68 which faces the main pole is set to become two tracks or smaller of a track pitch determined in the HDD.

The nonmagnetic cavities 65a and 65b are arranged at such positions that the shortest distance CG between the main pole 60 and each nonmagnetic cavity satisfies a relation of SG×3<CG<SG×5 in which SG is the shortest distance between the main pole 60 and the side shield 68. A distance CTH from the ABS 43 to the nonmagnetic cavity 65a or 65b is preferably higher than a distance NH from the ABS to a tapered portion of the main pole 60.

The nonmagnetic cavities 65a and 65b may be filled with a nonmagnetic material. The other constitutions of the recording head 58 and the magnetic head and the other constitutions of the HDD are the same as in the first embodiment.

Also in the second embodiment having the above constitution, when the side shields 68 are provided with the nonmagnetic cavities 65a and 65b having nonmagnetic properties, magnetic coupling of the main pole 60 with the side shields 68 can be weakened. It is possible to suppress the magnetic flux leaking from the side shields 68 to the recording layer of the magnetic disk 12, and to prevent information in an adjacent track from being erased. Moreover, a magnetic field strength in the center of the adjacent track is suppressed as compared with a conventional example. Moreover, the magnetic field strength in a track center increases. In consequence, a recording ability of an on-track signal is acquired, and the quality of the on-track signal can be enhanced. Therefore, a high track density of the recording layer of the magnetic disk 12 can be achieved, and the recording density of the HDD can be enhanced.

### Third Embodiment

Next, a recording head of an HDD according to a third embodiment will be described.

The recording head of the HDD according to the third embodiment is different from the first embodiment in a constitution further comprising a leading shield, and the other constitutions are the same as in the magnetic head according to the first embodiment. The same parts as in the first embodiment are denoted with the same reference numerals as in the first embodiment, and detailed description thereof will be omitted.

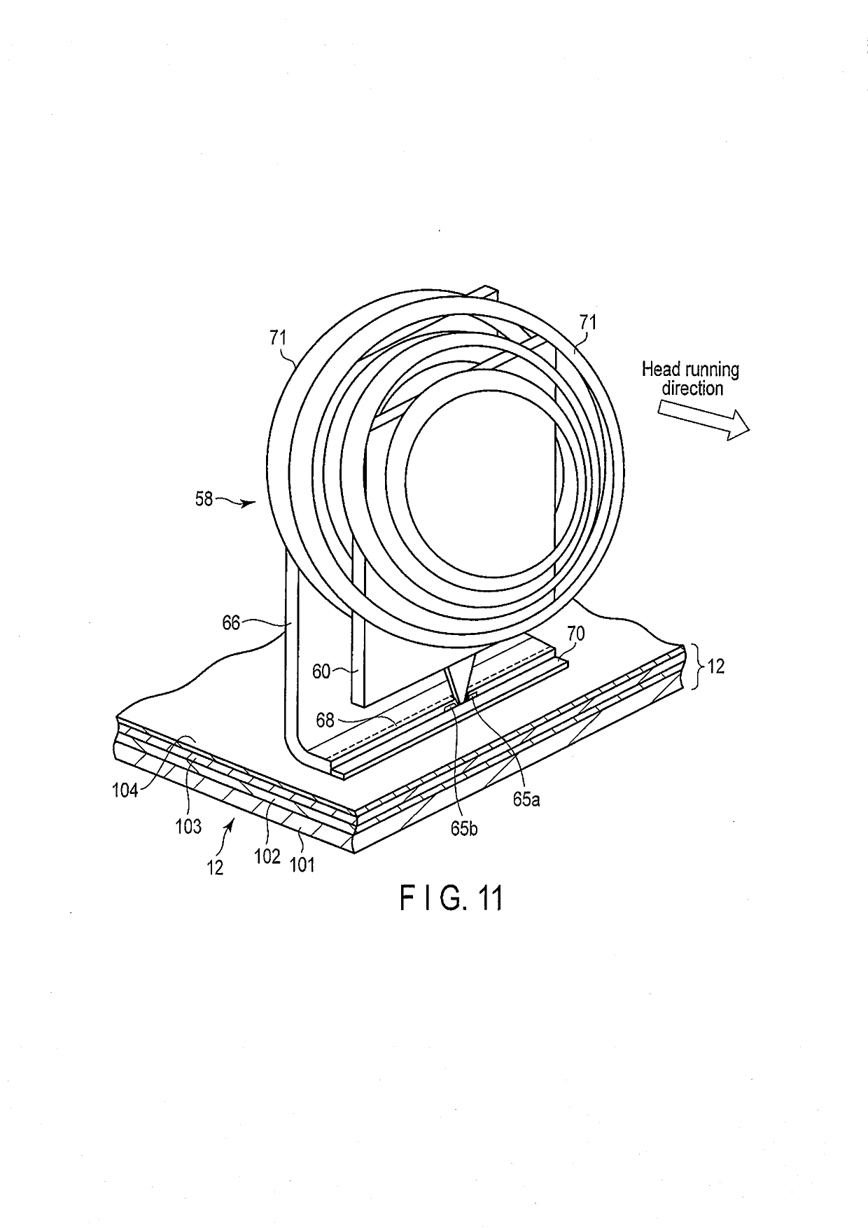

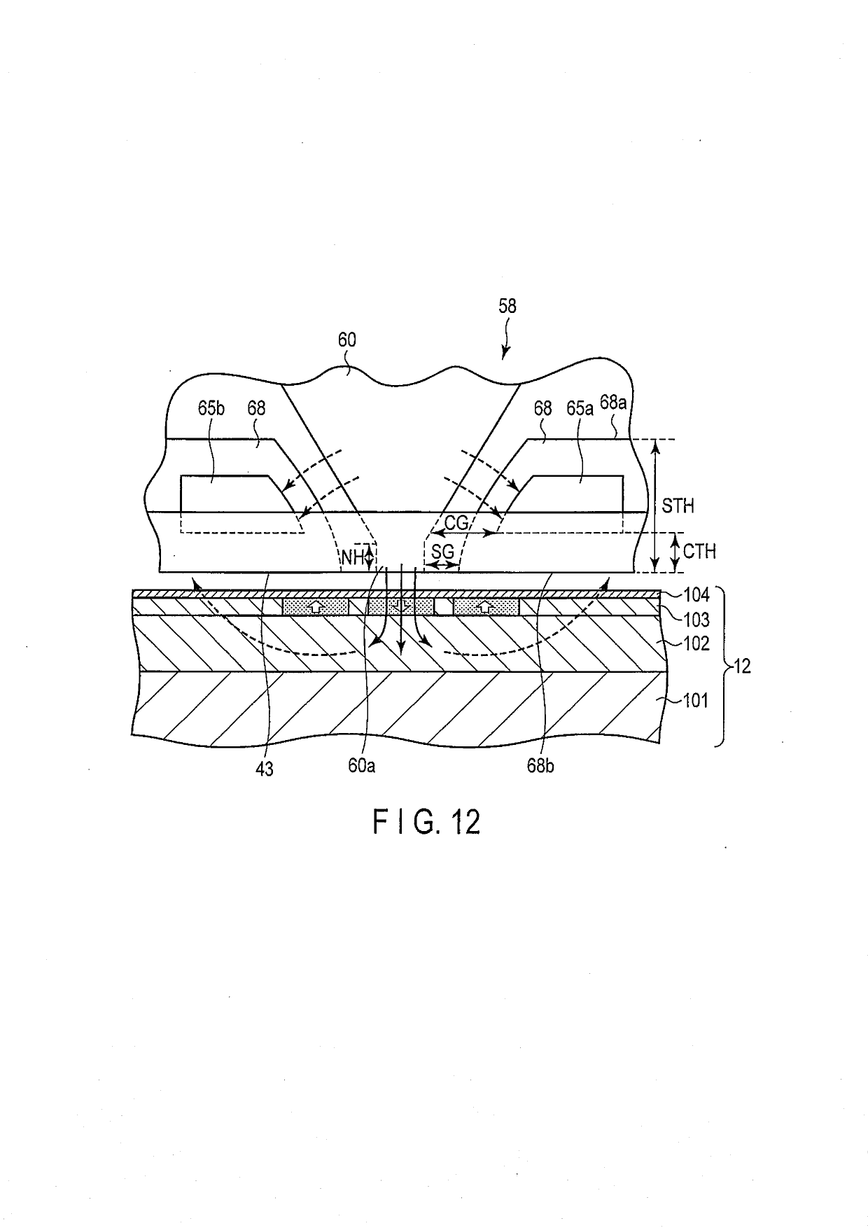

FIG. 11 is a perspective view schematically showing a recording head 58 of an HDD and a magnetic disk 12, and FIG. 12 is a side view of a recording head part seen from a leading end side of a slider.

As shown in FIG. 11 and FIG. 12, according to the third embodiment, the recording head 58 includes a main pole 60 made of a soft magnetic material having a high permeability and a high saturated magnetic flux density, to generate a recording magnetic field in a direction perpendicular to the surface of the magnetic disk 12; a write shield pole 66 made of a soft magnetic material, disposed on a trailing side of the main pole 60 with a write gap, and provided to efficiently close a magnetic path via a soft magnetic layer 102 right under the main pole; a connecting portion 67 connecting an upper portion of the main pole 60 to the write shield pole 66; a pair of side shields 68 made of a single layer of a soft magnetic material, on both sides of the main pole 60 in a track width direction on the magnetic pole and magnetically divided from the main pole at an ABS 43, and arranged to combine with the write shield pole 66; and a recording coil 71 disposed to wind around a magnetic path including the main pole 60 and the write shield pole 66, thereby passing magnetic flux through the main pole 60, when a signal is written in the magnetic disk 12. The side shields 68 include, in part thereof, nonmagnetic cavities 65a and 65b having nonmagnetic properties. A current to be supplied to the recording coil 71 is controlled by an HDD controller.

The pair of side shields 68 are formed of a high-permeability material integrally with a distal end portion 66a of the write shield pole 66, and project from the leading-side end surface of the distal end portion 66a toward a leading end side of a slider 42. The side shields 68 extend from the leading-side end surface of the write shield pole 66 to a level position beyond the leading-side end surface of the main pole 60.

In the third embodiment, the recording head 58 further comprises a leading shield 70 disposed away from the main pole on the ABS 43, on a leading side of the main pole 60. The leading shield 70 is formed of the nonmagnetic material integrally with the write shield pole 66 and the side shields 68. The nonmagnetic cavities 65a and 65b face the side surfaces of the main pole 60 and the surface of the magnetic disk 12 via magnetic regions of the side shields 68, respectively. That is, between the nonmagnetic cavity 65a or 65b and the main pole 60 and between the nonmagnetic cavity and the magnetic disk 12, the magnetic regions of the side shield 68 are present.

The other constitutions of the recording head 58 and the magnetic disk and the other constitutions of the HDD are the same as in the first embodiment.

Also in the third embodiment having the above constitution, when the side shields 68 are provided with the nonmagnetic cavities 65a and 65b having nonmagnetic properties, magnetic coupling of the main pole 60 with the side shields 68 can be weakened. It is possible to suppress the magnetic flux leaking from the side shields 68 to the recording layer of the magnetic disk 12, and to prevent information in an adjacent track from being erased. Moreover, a magnetic field strength in the center of the adjacent track is suppressed as compared with a conventional example. Moreover, the magnetic field strength in a track center increases. In consequence, a recording ability of an on-track signal is acquired, and the quality of the on-track signal can be enhanced. Therefore, a high track density of the recording layer of the magnetic disk 12 can be achieved, and the recording density of the HDD can be enhanced.

### Fourth Embodiment

Next, a recording head of an HDD according to a fourth embodiment will be described.

In the recording head of the HDD according to the fourth embodiment, a constitution of nonmagnetic cavities is mainly different from the first embodiment, and the other constitutions are the same as in the recording head of the first embodiment. The same parts as in the first embodiment are denoted with the same reference numerals as in the first embodiment, and detailed description thereof will be omitted.

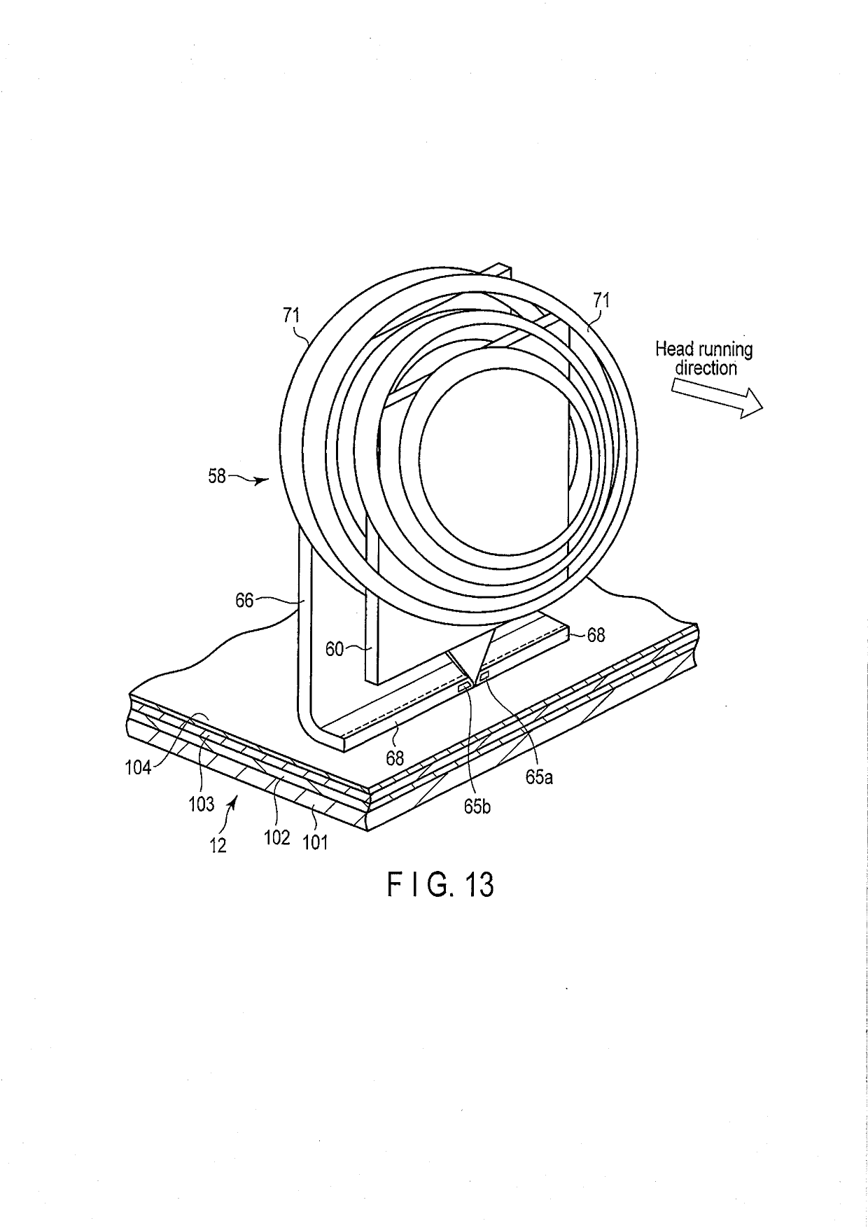

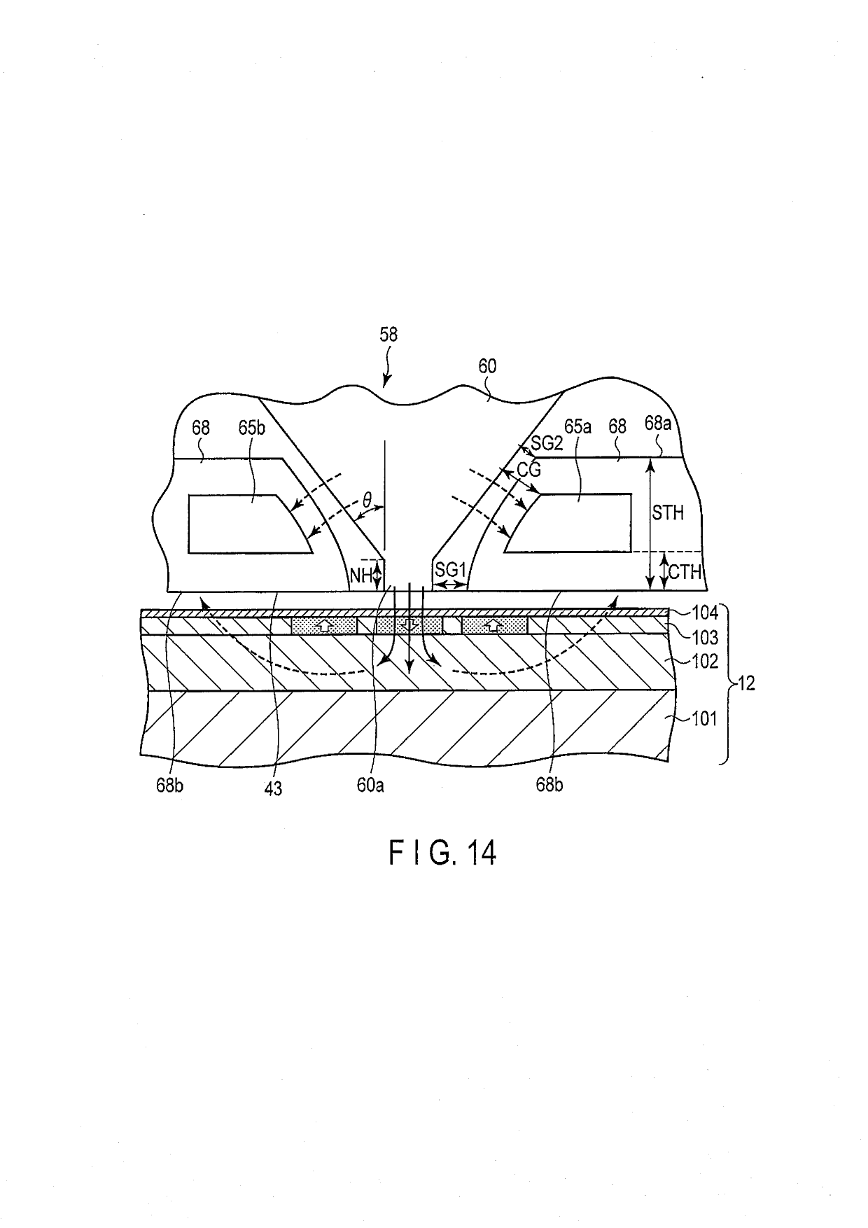

FIG. 13 is a perspective view schematically showing a recording head 58 of the HDD and a magnetic disk 12, and FIG. 14 is a side view of a recording head part seen from a leading end side of a slider.

As shown in FIG. 13 and FIG. 14, according to the fourth embodiment, the recording head 58 includes a main pole 60 made of a soft magnetic material having a high permeability and a high saturated magnetic flux density, to generate a recording magnetic field in a direction perpendicular to the surface of the magnetic disk 12; a write shield pole 66 made of a soft magnetic material, disposed on a trailing side of the main pole 60 with a write gap, and provided to efficiently close a magnetic path via a soft magnetic layer 102 right under the main pole; a connecting portion 67 connecting an upper portion of the main pole 60 to the write shield pole 66; a pair of side shields 68 made of a single layer of a soft magnetic material, on both sides of the main pole 60 in a track width direction on the main pole and magnetically divided from the main pole at an ABS 43, and arranged to combine with the write shield pole 66; and a recording coil 71 disposed to wind around a magnetic path including the main pole 60 and the write shield pole 66, thereby passing magnetic flux through the main pole 60, when a signal is written in the magnetic disk 12. The side shields 68 include, in part thereof, nonmagnetic cavities 65a and 65b having nonmagnetic properties. A current to be supplied to the recording coil 71 is controlled by an HDD controller.

The pair of side shields 68 are formed of a high-permeability material integrally with a distal end portion 66a of the write shield pole 66, and project from the leading-side end surface of the distal end portion 66a toward a leading end side of a slider 42. The side shields 68 extend from the leading-side end surface of the write shield pole 66 to a level position beyond the leading-side end surface of the main pole 60.

The nonmagnetic cavities 65a and 65b face the side surfaces of the main pole 60 and the surface of the magnetic disk 12 via magnetic regions of the side shields 68, respectively. That is, between the nonmagnetic cavity 65a or 65b and the main pole 60 and between the nonmagnetic cavity and the magnetic disk 12, the magnetic regions of the side shield 68 are present.

In the present embodiment, the main pole 60 and the side shields 68 are formed and arranged so that the shortest distance SG2 between the main pole 60 and the side shield 68 at a position away from the ABS 43 satisfies SG2<SG1 in which SG1 is a distance SG1 between the main pole 60 and the side shield 68 on the ABS 43.

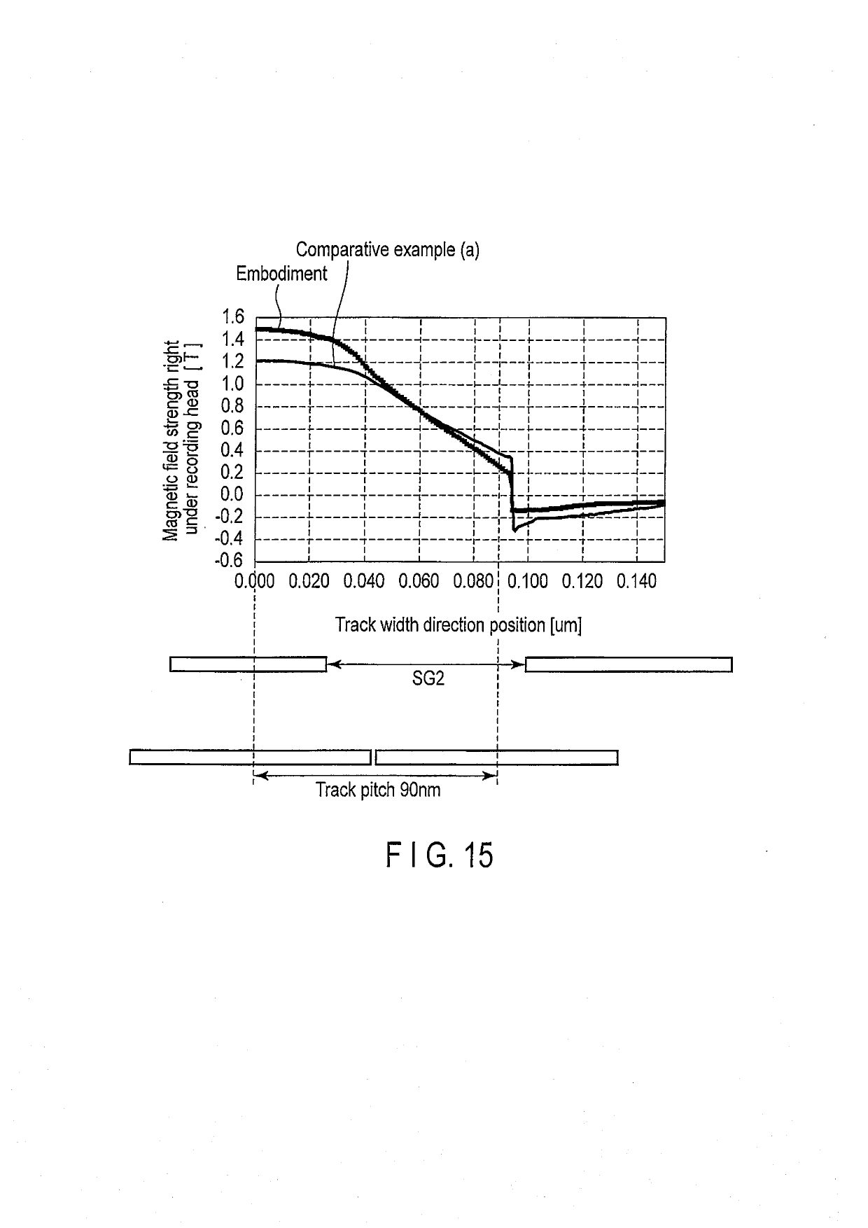

FIG. 15 compares and shows off-track direction profiles of recording magnetic field distributions generated from recording heads, concerning the recording head 58 in the HDD according to the present embodiment and the recording head according to comparative example (a). It is to be noted that in FIG. 15, the main pole 60 is formed of a material of a saturated magnetic flux density BS1=2.4 T, and the side shields 68 are formed of a material of a saturated magnetic flux density Bs3=1.9 T.

In FIG. 15, a position of a track width direction position=0 is a center position of the track width direction of the main pole 60 in the recording head. A line of black squares and a solid line indicate maximum magnetic field profiles at points in a one-side off-track direction from a track center in the head magnetic field distributions generated from the ABSs 43 of the recording head 58 of the present embodiment, and the recording head of the comparative example (a), respectively. The profiles with a track pitch of 90 nm are compared. For raising a track density, it is necessary to suppress the magnetic field distribution in the adjacent track, and to suppress an adjacent track erasing phenomenon. In the recording head 58 of the present embodiment, the magnetic field strength in the center of the adjacent track is suppressed as compared with the comparative example (a). Moreover, the magnetic field strength in the track center increases. When the recording head of such a head magnetic field distribution is used, the enhancement of a linear-direction density by improving an on-track signal SN and the enhancement of a track-direction density by suppressing the adjacent track erasing can be achieved. High-density recording can be realized.

As described above, in the HDD comprising the recording head according to the present embodiment, the recording ability of the on-track signal can be enhanced, and the erasing of the information of the adjacent track can be prevented. Therefore, it is possible to realize a high recording density.

In the present embodiment, the shortest distance SG1 between the side shield 68 and the main pole 60 on the ABS 43 is set to become two tracks or smaller of a track pitch determined in the HDD. The nonmagnetic cavities 65a and 65b are arranged at such positions that the shortest distance CG between the main pole 60 and each nonmagnetic cavity satisfies SG2×3<CG<SG2×5 in which SG2 is the shortest distance SG2 between the main pole 60 and the side shield 68 at the position away from a portion on the ABS 43. A distance CTH from the ABS 43 to the nonmagnetic cavity 65a or 65b is preferably higher than a distance NH from the ABS to the tapered portion of the main pole 60.

The nonmagnetic cavities 65a and 65b may be filled with a nonmagnetic material.

In the present embodiment, the magnetic field strength in the adjacent track center is suppressed as compared with the recording head of the comparative example. Moreover, a flare angle A in the main pole 60 can be increased, and hence the magnetic field strength in the track center also increases. In consequence, the recording head 58 according to the present embodiment can prevent information of the adjacent track from being erased, while acquiring the recording ability of the on-track signal. It is possible to contribute to the high recording density of the HDD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, materials, shapes, sizes and the like of elements constituting the head section can be changed if necessary. Moreover, in a magnetic disk drive, the number of magnetic disks and the number of magnetic heads can be increased if necessary, and sizes of the magnetic disks can variously be selected.

What is claimed is:

1. A recording head comprising:
a main pole formed of a soft magnetic material and configured to generate a recording magnetic field in a direction perpendicular to a recording layer of a recording medium;
a write shield pole formed of a soft magnetic material and on a trailing side of the main pole with a write gap; and
side shields on both sides of the main pole in a track width direction and magnetically divided from the main pole and comprising nonmagnetic cavities formed of a nonmagnetic material in inner portions of the side shields,
wherein the side shields comprise surfaces formed of a soft magnetic material and configured to be between a distal end portion of the main pole and the nonmagnetic cavity and between the recording medium and the nonmagnetic cavity.

2. The recording head of claim 1, wherein the shortest distance CG between the main pole and each of the nonmagnetic cavities satisfies a relation of
SG×3<CG<SG×5
in which SG is the shortest distance between the main pole and each of the side shields.

3. The recording head of claim 2, wherein a part of the nonmagnetic cavity opens in a boundary surface between the main pole and an upper portion of the side shields.

4. The recording head of claim 3, further comprising a leading shield on a leading side of the main pole with a gap, and formed of a soft magnetic material integrally with the side shields.

5. The recording head of claim 4, wherein the distance SG between the main pole and each of the side shields is largest at a lower surface of the side shield which faces the recording medium, and smaller at a position away from the lower surface.

6. The recording head of claim 1, wherein a part of the nonmagnetic cavity opens in a boundary surface between the main pole and an upper portion of the side shields.

7. The recording head of claim 6, further comprising a leading shield on a leading side of the main pole with a gap, and formed of a soft magnetic material integrally with the side shields.

8. The recording head of claim 7, wherein a distance SG between the main pole and each of the side shields is largest at a lower surface of the side shield which faces the recording medium, and smaller at a position away from the lower surface.

9. The recording head of claim 1, further comprising a leading shield on a leading side of the main pole with a gap, and formed of a soft magnetic material integrally with the side shields.

10. The recording head of claim 1, wherein a distance SG between the main pole and each of the side shields is largest at a lower surface of the side shield which faces the recording medium, and smaller at a position away from the lower surface.

11. A disk drive comprising:
a recording medium comprising an underlayer having soft magnetic characteristics, and a recording layer formed above the underlayer and having a magnetic anisotropy in a direction perpendicular to a medium surface;
a drive section configured to rotate the recording medium; and
a magnetic head comprising a slider comprising a surface configured to face a surface of the recording medium, and the recording head of claim 1, on the slider and configured to process information on the recording medium.

12. The disk drive of claim 11, wherein the shortest distance CG between the main pole and each of the nonmagnetic cavities satisfies a relation of
SG×3<CG<SG×5
in which SG is the shortest distance between the main pole and each of the side shields.

13. The disk drive of claim 12, wherein a part of the nonmagnetic cavity opens in a boundary surface between the main pole and an upper portion of the side shields.

14. The disk drive of claim 13, further comprising a leading shield on a leading side of the main pole with a gap, and formed of a soft magnetic material integrally with the side shields.

15. The disk drive of claim 14, wherein the distance SG between the main pole and each of the side shields is largest at a lower surface of the side shield which faces the recording medium, and smaller at a position away from the lower surface.

16. The disk drive of claim 11, wherein a part of the nonmagnetic cavity opens in a boundary surface between the main pole and an upper portion of the side shields.

17. The disk drive of claim 16, further comprising a leading shield on a leading side of the main pole with a gap, and formed of a soft magnetic material integrally with the side shields.

18. The disk drive of claim 17, wherein a distance SG between the main pole and each of the side shields is largest at a lower surface of the side shield which faces the recording medium, and smaller at a position away from the lower surface.

19. The disk drive of claim 11, further comprising a leading shield on a leading side of the main pole with a gap, and formed of a soft magnetic material integrally with the side shields.

20. The disk drive of claim 11, wherein a distance SG between the main pole and each of the side shields is largest at a lower surface of the side shield which faces the recording medium, and smaller at a position away from the lower surface.
